(19) United States
(12) Patent Application Publication
(10) Pub. No.: US 2022/0047974 A1
(43) Pub. Date: Feb. 17, 2022

(54) APPARATUS FOR REDUCING PRESSURE FLUCTUATION

(71) Applicant: BHS-Sonthofen GmbH, Sonthofen (DE)

(72) Inventors: Martin Schäfer, Sonthofen (DE); Axel Detlef Steidl, Ofterschwang (DE); Wolfgang Süss, Sonthofen (DE)

(73) Assignee: BHS-Sonthofen GmbH, Sonthofen (DE)

(21) Appl. No.: 17/279,274

(22) PCT Filed: Oct. 31, 2018
(86) PCT No.: PCT/EP2018/079817

§ 371 Date: Mar. 24, 2021

(51) Int. Cl. B01D 33/09; B01D 33/80; B01D 33/11; B01D 33/48; B01D 33/72

(52) U.S. Cl. CPC B01D 33/09; B01D 33/808; B01D 2201/34; B01D 33/48; B01D 33/722; B01D 33/11

(57) ABSTRACT

The present invention relates to a rotary pressure filter, comprising a filter housing, and a filter drum, wherein a plurality of treatment zones comprises at least a suspension insertion zone and a discharge zone, wherein the rotary pressure filter is configured such that a pressure being present in the suspension insertion zone is higher than a pressure being present in the discharge zone, and that, each time a filter cell, coming from the discharge zone and containing gas having the discharge zone's pressure, enters the suspension insertion zone, the pressure of the suspension insertion zone drops, characterized in that the rotary pressure filter further comprises equipment that is configured to reduce and/or to slow the pressure drop of the pressure in the suspension insertion zone each time a filter cell coming from the discharge zone enters the suspension insertion zone.

The present invention relates to a rotary pressure filter, comprising a filter housing, and a filter drum rotatable around a rotation axis and accommodated inside the filter housing, wherein the filter drum comprises a plurality of filter cells arranged in a succeeding manner in a peripheral direction of the filter drum, wherein the rotary pressure filter is divided into a plurality of treatment zones which are separated by sealing elements, wherein the plurality of treatment zones comprises at least a suspension insertion zone which is adapted to introduce a suspension to be filtered into the filter housing an onto the filter cells, and a discharge zone which is adapted to remove a filter cake being the solid result of the filtration of the suspension from the filter cells, and wherein the rotary pressure filter is configured in its operating state such that a pressure being present in the suspension insertion zone is higher than a pressure being present in the discharge zone, and that, each time a filter cell, coming from the discharge zone and containing gas having the discharge zone's pressure, enters the suspension insertion zone, the pressure of the suspension insertion zone drops.

Rotary pressure filters are known for many years in the field of filtrating a suspension comprising solid particles and a liquid component. In rotary pressure filters of the known type, the suspension is filtered through filter cells, wherein the filter cells comprise a mesh or fabric that is adapted to let pass the liquid component of the suspension and to hold back the solid particles of the suspension.

The solid particles form a so-called “filter cake” on the filter cell may be removed from a respective filter cell at the end of a filtration cycle. Usually, this is performed by a scraping unit in a lower part of the rotary pressure filter, e.g. using the gravity force to convey the filter cake out of the system.

Even, when installing a gate between an environment around the rotary pressure filter and the inside of the rotary pressure filter, especially at the treatment zone comprising the scraping unit, also called “discharge zone”, a pressure in the discharge zone is often close to an environmental pressure, e.g. 1 bar, wherein a pressure in a suspension insertion zone in which suspension is introduced onto the filter cells is much higher, e.g. 6 to 7 bar.

After the filter cake is discharged from a respective filter cell, at least the space of the filter cell in close vicinity to the mesh/fabric of a respective filter cell, e.g. the space where the filter cake used to be, is filled with a gas having the pressure of the discharge zone. In its operating state, the rotary pressure filter rotates the filter drum such that the above-mentioned filter cell subsequently enters the suspension insertion zone. After passing a sealing element that is separating the discharge zone from the suspension insertion zone in an airtight manner, the gas and/or liquid being present in the suspension insertion zone expands rapidly into the “fresh” filter cell resulting in a pressure drop of the pressure inside the suspension insertion zone.

This pressure drop affects the efficiency of the rotary pressure filter, since it takes some time to build up the operational pressure for introducing the suspension onto the filter cells correctly. Furthermore, a repeating pressure drop and pressure build-up may stress the components of the rotary pressure filter resulting in a reduced lifetime of the system.

It is therefore an object of the present invention to provide a rotary pressure filter which shows a reduced, if not even eliminated, pressure drop each time a filter cell coming from the discharge zone enters the suspension insertion zone.

This object is solved by a rotary pressure filter of the type described above which further comprises equipment that is configured to reduce and/or to slow the pressure drop of the pressure in the suspension insertion zone each time a filter cell coming from the discharge zone enters the suspension insertion zone

In general, it was due to the effort of the inventors of this invention who investigated the reasons for the pressure drop and who discovered the negative effects of this pressure drop so that they came up with the idea to provide a rotary pressure filter that is configured to reduce the pressure drop by using additional equipment.

By reducing the pressure drop, a more efficient filtration and a more continuous introduction of suspension onto the filter cells is possible.

In an embodiment of the present invention the equipment may comprise a liquid insertion zone as a separate treatment zone separated by sealing elements from the other treatment zones, located, with respect to the rotation direction of the filter drum, prior to the suspension insertion zone and after the discharge zone, wherein the liquid insertion zone is adapted to introduce liquid into the filter housing an onto the filter cells. Therefore, the filter cells may be at least partially prefilled with liquid when entering the suspension insertion zone. The incompressible liquid in the filter cells may block the expansion of the gas being present in the suspension insertion zone into the filter cells. As a result, the pressure in the suspension insertion zone may stay at least almost constant when a filter cell is entering the suspension insertion zone.

The liquid introduced in the liquid insertion zone may be fresh water and/or washing liquid and/or filtrate and/or mother filtrate being the liquid result of the filtration of the suspension of a previous filtration cycle. Especially when using mother filtrate as liquid, the liquid part of the filtration result, i.e. the part of the suspension being able to pass through the filter cell and into a drainage duct, may be fed into the liquid insertion zone prior to being discharged from the rotary pressure filter.

In an alternative embodiment of the present invention the equipment may comprise a further suspension insertion zone, as a separate treatment zone separated by sealing elements from the other treatment zones, located, with respect to the rotation direction of the filter drum, prior to the suspension insertion zone and after the discharge zone, wherein the further suspension insertion zone is adapted to introduce suspension into the filter housing an onto the filter cells. Thus, the filter cells may at least partially be prefilled with suspension and/or with a filter cake when entering the suspension insertion zone. Even if there is no liquid component present in the filter cell or its drainage duct, having a similar effect as using mother filtrate as liquid, also the filter cake formed on a respective filter cell may provide an increased resistance for the gas of the suspension insertion zone to expand into the filter cell. As a result, the pressure in the suspension insertion zone may stay at least almost constant when a filter cell is entering the suspension insertion zone.

In order to supply suspension to the further suspension insertion zone, it may be connected to a first suspension pump conveying suspension to the suspension insertion zone, and the further suspension insertion zone may be connected to a second suspension pump conveying suspension to the further suspension insertion zone, wherein the first suspension pump may be different from the second suspension pump.

In an alternative embodiment of the present invention the equipment may comprise that a drainage duct, that is adapted to guide filtrate being filtered through the filter cells out of the filter housing, is in fluid connection with a further treatment zone being succeeding to the suspension insertion zone, and the suspension insertion zone may be closed to the drainage duct such that filtrate being filtered in the suspension insertion zone may leave the filter drum in the succeeding further treatment zone at earliest. That is, the suspension insertion zone has no opening to the drainage duct such that the gas being present in the suspension insertion zone may not expand further than into the filter cells and, if applicable, into a space downstream of the filter cells which rotates together with the filter drum. As a result, the pressure in the suspension insertion zone may stay at least almost constant when a filter cell is entering the suspension insertion zone.

In an alternative embodiment of the present invention the equipment may comprise a gas insertion device being arranged at the suspension insertion zone, wherein the gas insertion device may be adapted to introduce gas, such as air, into the suspension insertion zone being additional to the gas already present in the suspension insertion zone. When the pressure of the gas being present in the suspension insertion zone drops, e.g. due to a filter cell entering the suspension insertion zone, the gas insertion device is adapted to introduce gas into the suspension insertion zone in order to compensate for the increased volume available for the gas inside the suspension insertion zone.

Here, the equipment may further comprise a check valve that is located, with respect to the gas flow inserted into the suspension insertion zone, on an upstream position of the gas insertion device which is adapted to prevent suspension to exit the suspension insertion zone through the gas insertion device. The check valve, as known, is adapted to only allow a passage in one direction and to prevent a passage in the other direction. By using a check valve, the gas insertion device is adapted to only supply gas to the suspension insertion zone but does not receive gas and/or suspension from the suspension insertion zone.

Advantageously, the equipment may further comprise a pressure detection unit that is adapted to detect the pressure inside the suspension insertion zone, and a gas pump that is adapted to introduce gas into the suspension insertion zone when the pressure inside the suspension insertion zone detected by the pressure detection unit falls below a predetermined value. It is therefore ensured that the gas insertion device is only activated when the pressure inside the gas insertion device drops below the predetermined value, e.g. below 6 to 7 bar. Hence, an insertion of gas which may lead to an undesired overpressure may be prevented.

The gas insertion device may also comprise a gas reservoir portion that is adapted to be filled with compressed gas prior to an operation of the rotary pressure filter. The gas reservoir portion of the gas insertion device may provide a simple embodiment of balancing the pressure inside the suspension insertion zone. When connecting the interior of the gas reservoir portion to the suspension insertion zone in a fluid communicating manner, a pressure balance may be generated such that the pressure inside the suspension insertion zone and the pressure inside the gas reservoir portion are the same. As soon as the pressure inside the suspension insertion zone drops, the overpressure of the gas reservoir portion expands into the suspension insertion zone and thereby reduces the pressure drop of the suspension insertion zone's pressure.

In an embodiment of the invention, the gas reservoir portion may comprise an opening being in fluid connection with the inside of the filter housing, and the opening of the gas reservoir portion may be located in the lower half, preferably at the bottom, of the gas reservoir portion with respect to a vertically orientation of the gas reservoir portion in its mounting state. By arranging the opening in the lower half, preferably at the bottom, of the gas reservoir portion with respect to a vertically orientation of the gas reservoir portion in its mounting state it may be ensured that the gas reservoir portion is not permanently obstructed by incompressible material having entered the gas reservoir portion and thus reducing the volume of the gas reservoir portion.

The gas reservoir portion may comprise an extendible portion that is formed by a stretchable material and/or by a folded wall structure. The stretchable material may, for example, be made of a plastic material. The folded wall structure may, for example, be formed like a bellows. The gas reservoir portion may also be made from a rigid material, e.g. metal or plastics.

Furthermore, the gas reservoir portion may be adapted to accommodate suspension from the suspension insertion zone such that the pressure inside the suspension insertion zone and the gas pressure inside the gas reservoir portion are balanced. It is therefore ensured that, even if there is not sufficient gas inside the suspension insertion zone to fill the gas reservoir portion creating a pressure balance between the suspension insertion zone and the inside of the gas reservoir portion, a pressure balance may still be achieved by allowing suspension to enter into the gas reservoir portion. The suspension entered into the gas reservoir portion may be expelled from it due to an expansion of the gas of the gas reservoir portion, since there may be, in a pressure balanced state, gas present above the suspension which may expand when a pressure drop occurs in the suspension insertion zone.

Advantageously, the gas reservoir portion may be arranged outside of the filter housing. The gas insertion device may further comprise a valve that is adapted to let gas pass into the gas reservoir portion from outside, e.g. supplied by a source for pressurized gas. By arranging the gas reservoir portion outside of the filter housing, an easy access to the gas reservoir portion and/or the valve is ensured in order to refill the total gas volume inside the combined spaces of the suspension insertion zone and inside of the gas reservoir portion. Due to leakage and/or gas which leaves the system through the drainage duct a gradually reduction of the gas volume may occur.

In an alternative embodiment of the present invention the equipment may comprise at least one sealing element that is chamfered on an edge facing the filter drum and facing the suspension insertion zone such that a filter cell entering the suspension insertion zone opens to the suspension insertion zone in a single point, wherein the area of the filter cell being open to the suspension insertion zone enlarges when the filter drum rotates the respective filter cell further into the suspension insertion zone. By establishing a fluid connection between the filter cell and the suspension insertion zone beginning in one single point, namely the point of the chamfer which is located closest to the discharge zone, assuming that the edges dividing the filter cells are arranged perpendicular to the rotation direction of the filter drum. Of course, it is also conceivable to provide inclined edges of the filter cells with respect to the rotation direction of the filter drum, wherein the effect stays the same as long as a fluid communication between the filter cells and the suspension insertion zone is at first only established in a very restricted area, e.g. a single or only very few areas having an extension of below 1 cm². By rotating the filter drum further in its rotation direction, the fluid communication between the filter cells and the suspension insertion zone may enlarge. It is thus ensured that the pressure drop is slowed down. The pressure drop may also be reduced in this way because of the suspension entering the suspension insertion zone while the connecting area of the filter cell to the suspension insertion zone enlarges.

In the following the present invention will be described in more detail with respect to several embodiments, wherein reference is made to the accompanying drawing in which:

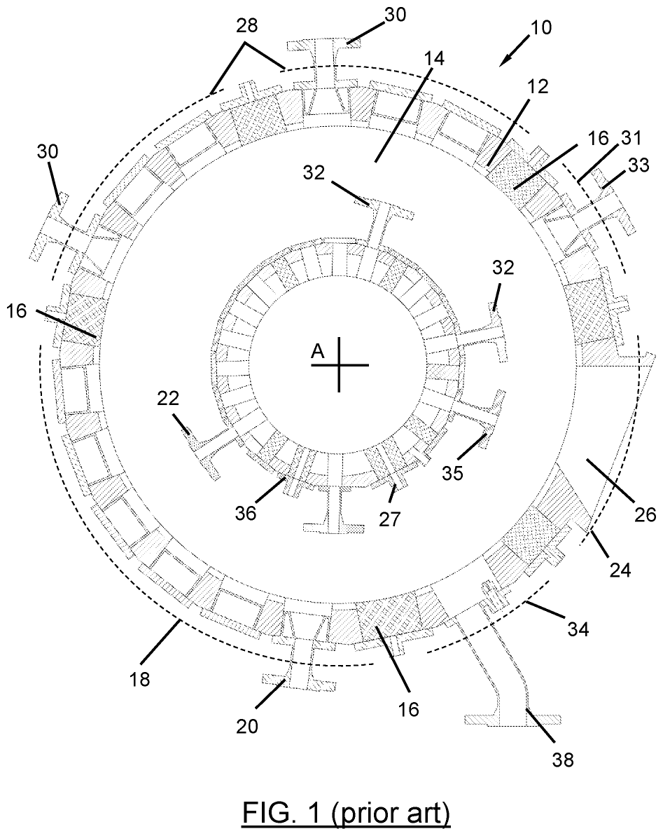

FIG. 1 shows a side sectional view of a rotary pressure filter as known in the state of the art;

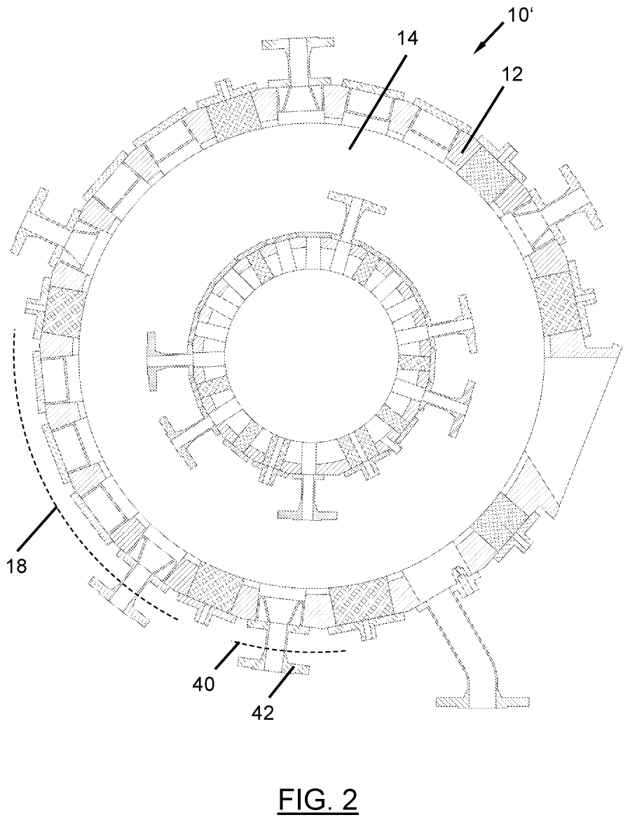

FIG. 2 shows a side sectional view of a first embodiment of a rotary pressure filter according to the present invention;

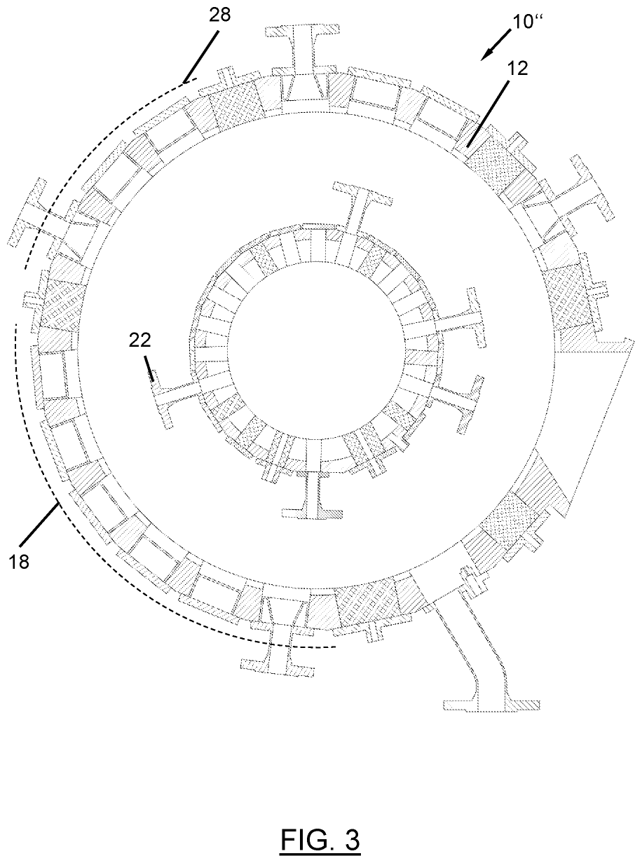

FIG. 3 shows a side sectional view of a second embodiment of a rotary pressure filter according to the present invention;

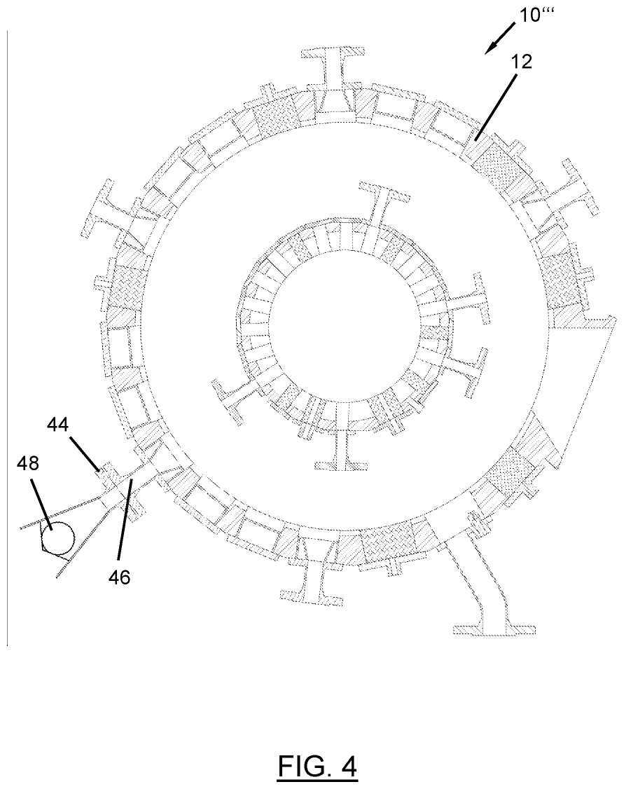

FIG. 4 shows a side sectional view of a third embodiment of a rotary pressure filter according to the present invention;

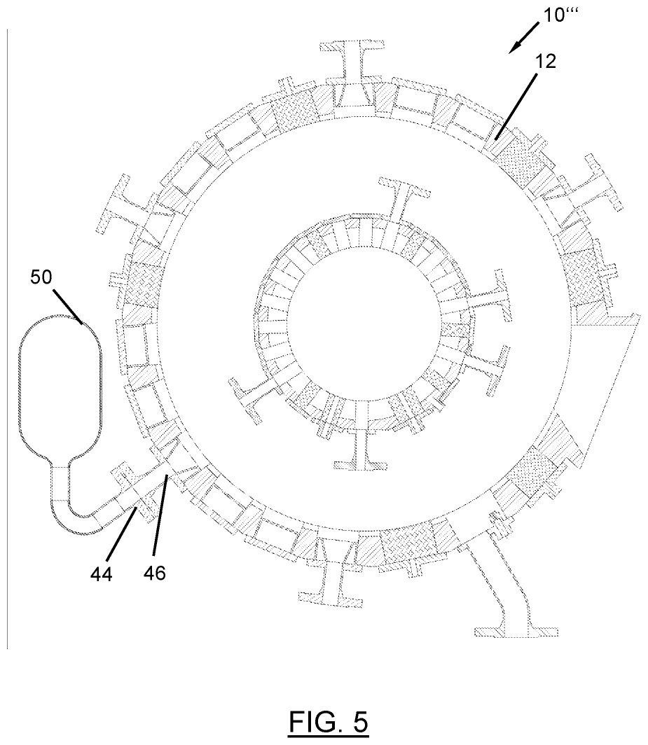

FIG. 5 shows a side sectional view of a forth embodiment of a rotary pressure filter according to the present invention;

In FIG. 1, a rotary pressure filter as it is known in the state of the art is generally denoted with the reference numeral 10.

The rotary pressure filter 10 comprises a filter housing 12 which, in the side sectional view of FIG. 1, shows a substantially annular extension. Inside the filter housing 12 a filter drum 14 (which is not shown in detail but its position is indicates with the reference numeral 14) rotates around a rotation axis A in a rotation direction U.

The filter drum 14 comprises plural filter cells that are adapted to receive suspension to be filtered and to separate a liquid component of the suspension from solid particles of the suspension. The filter may, therefore, comprise a filter cloth and/or a filter mesh such that the liquid component of the suspension passes the filter cloth and/or filter mesh and the solid particles remain on it. The liquid component typically then leaves the rotary pressure filter 10 via a duct system which is located on the inside of the rotary filter drum 14.

The filter housing 12 comprises a plurality of sealing elements 16 that are pressed onto the outside of the filter drum 14 in a manner that a space between the filter housing 12 and the filter drum 14 on one side of the sealing element 16 is separated from a space between the filter housing 12 and the filter drum 14 on the other side of the sealing element 16 in an air-tight and liquid-tight manner. Hence, the sealing element 16 may have a larger extension in the circumferential direction of the filter drum 14 than any of the filter cells, i.e. when a filter cell is passing a respective sealing element 16, there is a position in which the sealing element 16 is fully covering the opening of the filter cell.

Each of those spaces between the filter housing 12 and the filter drum 14 may be regarded as a single treatment zone in which the suspension to be filtered and/or the components of the suspension that remain in the filter cell is treated differently, e.g. washed, dried or removed from a respective filter cell. In FIG. 1, a first treatment zone is designed as a suspension insertion zone 18. The suspension insertion zone 18 is provided with a suspension inlet 20 having an opening through which suspension may enter the treatment zone 18 and the filter cells of the filter drum 14 that currently are located in the first treatment zone 18. The suspension insertion zone 18 is also provided with an outlet 22 that is arranged on the inside of the filter drum 14 (belonging to the duct system mentioned above) and through which a liquid component of the suspension may leave the rotary pressure filter 10.

At the end of a filtration cycle, the rotary pressure filter 10 comprises a discharge zone 24 through which a solid component of the suspension remaining on the filter cell can be removed from a respective filter cell and transferred out of the filter housing 12. For example, the discharge zone 24 may comprise a scraping device (not shown) that is adapted to remove a filter cake built on a filter cell, e.g. by using a blade. In the embodiment shown in FIG. 1, the filter cake removed from the filter cell may then fall through an opening 26 of the discharge zone 24 and out of the filter housing 12 because of its own weight. Here, the discharge zone 24 is also provided with a gas inlet 27 which additionally supports the removal of the filter cake from a respective filter cell by blowing gas from an inside of the rotary filter drum 10 through the filter cell.

In the example of FIG. 1, the rotary pressure filter 10 further comprises two washing zones 28 each provided with an inlet 30 for washing liquid and an outlet 32 for a mixture of the washing liquid and a liquid component of the suspension.

It shall be mentioned at this point that the term “liquid component of the suspension” is not strictly limited to liquids but may also comprise small particles that are small enough to pass the barrier of the filter cell, i.e. the cloth and/or mesh.

A zone 31 represents a drying zone in which dry air is introduced into the filter housing 12 through an inlet 33. The dry air passes the filter cake formed in and on a respective filter cell and leaves the rotary pressure filter 10 through an outlet 35. Thereby remaining liquids may be further removed from the filter cake.

The rotary pressure filter 10 of FIG. 1 furthermore comprises a cleaning zone 34 which is provided with an inlet 36 for a cleaning liquid, such as water, and/or gas and an outlet 38. In the cleaning zone 34, a flow of liquid and/or gas through the filter cell is reversed compared to the other treatment zones 18, 24, 28 such that the flow through the filter cell is coming from an inside of the filter drum 14 and is directed to the filter housing 12. Therewith, any filter cake remaining on a respective filter cell, after the filter cell has passed the discharge zone 24, may be washed out of the filter cell. Because the filter cells are cleaned like that, the filtration effect stays constant even over a long usage of the rotary pressure filter 10.

It is to be understood that a pressure in a space between the filter housing 12 and the filter drum 14 that is located in the suspension insertion zone 18 is much higher, e.g. 6 to 7 bar, than in a corresponding space that is located in the discharge zone 24, where usually ambient pressure (a pressure existing on an outside of the filter housing 12) is existent, e.g. 1 bar, or in a space of the cleaning zone 34. The duct system, especially the outlet 22, may run dry after a liquid component (or, in later treatment zones, a washing liquid) has left the rotary pressure filter 10 such that there is gas existent in the duct system at ambient pressure. Each time a “fresh” filter cell is entering the suspension insertion zone 18 a connection is established between the space between the filter housing 12 and the filter drum 14 and the outlet 22 resulting in a rapid pressure drop, as described here in the introduction. On the one hand, this may reduce the effectivity of the filtration, and on the other hand, the rotary pressure filter 10 is stressed extensively by the rapid changes of pressure.

In order to overcome these negative effects, several approaches may be described in the following with reference to the embodiments of FIGS. 2 to 5, wherein it is explicitly pointed out that all features and advantages mentioned with respect to FIG. 1 are also applicable to the embodiments of FIGS. 2 to 5. Hence, the embodiments of FIGS. 2 to 5 are only described with respect to their differences compared to the stand of the art rotary pressure filter 10 of FIG. 1. Same components are, therefore, denoted with the same reference numerals.

In the embodiment of FIG. 2, the suspension insertion zone 18 is shortened. Directly prior (with respect to the rotation direction U of the filter drum 14) to the suspension insertion zone 18 a liquid insertion zone 40 is inserted as an additional treatment zone. The liquid insertion zone 40 comprises an inlet 42 but no associated outlet. Thus, the filter cells are filled with liquid in the treatment zone 40. When the filter cells filled with liquid enter the suspension insertion zone 18, the suspension has to replace the liquid already present in the filter cells. As commonly known, the liquid in the filter cell is incompressible and, therefore, the pressure drop, which mainly results from a compression of a gas present in filter cells of prior art devices, can be reduced if not even eliminated. The liquid may be any suitable liquid but it is favorable to use mother filtrate of previous filtration cycles, i.e. the filtered liquid component of a suspension already filtered, as this liquid is easily available in the system of a rotary pressure filter. Of course, it is also conceivable to use fresh water or a washing liquid, for example.

In another favorable embodiment, suspension itself may be used as this liquid to be filled into the filter cells in the liquid insertion zone 40. It is conceivable to use a suspension that is to be filtered by the rotary pressure filter 10′. The suspension is inserted into the liquid insertion zone 40 through the inlet 42. Thus, a respective filter cell and the part of the duct system that follows the filter cloth and/or mesh and rotates with the filter drum 14 are already prefilled with suspension when the filter cell enters the suspension insertion zone 18 having the above-described effect of a reduced pressure drop. Furthermore, a thin layer of filter cake may already be built on the filter cell. This may reduce the flow rate of the suspension in the suspension insertion zone 18 through the filter cell which additionally may reduce the pressure drop because of the barrier effect of the filter cake layer.

In order to supply suspension to the liquid insertion zone 40 a suspension pump may be provided for the rotary pressure filter 10′ that may be separate from a suspension pump which supplies suspension to the suspension insertion zone 18.

In the embodiment of the rotary pressure filter 10″ of FIG. 3, the outlet 22 of the suspension insertion zone 18 is blocked or removed. In fact, the outlet 22 is relocated from the suspension insertion zone 18 into an adjacent succeeding treatment zone which in the embodiment of FIG. 3 is the washing zone 28. Since the suspension insertion zone 18 has no outlet, the suspension inserted in the suspension insertion zone 18 fills all filter cells currently present in the suspension insertion zone 18 and respective ducts that each are associated to a respective filter cell and are situated on a radial inner side of the filter drum 14 with respect to the filter cloth/mesh of the filter cell. But as the filter cells and the associated ducts, respectively, are closed on their duct system side, only the amount of gas present in the filter cell and the associated duct has to be replaced by the suspension. This may reduce the pressure drop significantly. When the filter cell filled with suspension enters the succeeding washing zone 28, the suspension may be washed out of the filter cell and the associated duct through the outlet 22.

Referring now to the embodiment of FIG. 4, a standard rotary pressure filter, as described with respect to FIG. 1, is additionally equipped with a gas insertion device 44 being arranged at the suspension insertion zone 18. The gas insertion device 44 of rotary pressure filter 10′″ is adapted to introduce gas, such as air, into the suspension insertion zone 18. The gas insertion device 44 is connected to the suspension insertion zone 18 via a port 46 through which gas is entered into the suspension insertion zone 18. To supply the gas, the gas insertion device 44 may, for example, comprise a gas pump (not shown). Within the path of the gas a check valve 48 is inserted. The check valve 48 may prevent suspension and/or gas from leaving the suspension insertion zone 18 and flowing into the gas pump of the gas insertion device 44.

The gas insertion device 44 or the gas pump of the gas insertion device 44, respectively, may be adjusted to supply gas having a predefined pressure, e.g. 6 to 7 bar, to the suspension insertion zone 18. In a balanced state, the pressure that is present inside the suspension insertion zone 18, i.e. in the space between the filter housing 12 and the filter drum 14, corresponds to the predefined pressure of the gas insertion device 44. As soon as the pressure in the suspension insertion zone 18 drops, because of a “fresh and empty” filter cell entering the suspension insertion zone 18, the gas insertion device 44 supplies additional gas to the suspension insertion zone 18. Thus, a pressure drop is rapidly returned to the balanced state resulting in a reduced and shortened pressure drop. This effect is also based on the fact that gas being present on the gas pump side of the check valve 48 may expand quickly when the pressure decreases inside the suspension insertion zone 18.

In order to determine a pressure inside the suspension insertion zone 18 and/or of the gas insertion device 44, a pressure determination unit (not shown) such as a pressure sensor may be provided.

The embodiment of FIG. 5 only differs slightly from the embodiment of FIG. 4. Here, the gas insertion device 44 comprises a gas reservoir portion 50 instead of a gas pump. The gas reservoir portion 50 is prefilled with gas having a predefined pressure, e.g. 7 bar. The balancing effect of the gas reservoir portion 50 is the same as the one of the gas pump of the embodiment of FIG. 4.

Also, the check valve 48 is removed. In order to avoid suspension entering the gas reservoir portion 50 and in order to avoid that all gas leaves the gas reservoir portion 50, the gas reservoir portion 50 is connected on its bottom to the port 46. Even if suspension enters the gas reservoir portion 50, it may be expelled with a next balancing action. If a pressure in the suspension insertion zone 18 exceeds a predefined value, gas may flow back into the gas reservoir portion 50 from the suspension insertion zone 18. Compared to the embodiment of FIG. 4, the gas reservoir portion 50 may be driven only based on the prefilled gas pressure and/or on resilient properties of the gas reservoir portion 50, e.g. a rubber balloon.

1. A rotary pressure filter, comprising
a filter housing, and
a filter drum rotatable around a rotation axis and accommodated inside the filter housing,
wherein the filter drum comprises a plurality of filter cells arranged in a succeeding manner in a peripheral direction of the filter drum,
wherein the rotary pressure filter is divided into a plurality of treatment zones which are separated by sealing elements,
wherein the plurality of treatment zones comprises at least a suspension insertion zone which is adapted to introduce a suspension to be filtered into the filter housing and onto the filter cells, and a discharge zone which is adapted to remove a filter cake being a solid result of filtration of the suspension from the filter cells, and
wherein the rotary pressure filter is configured in its operating state such that a pressure being present in the suspension insertion zone is higher than a pressure being present in a discharge zone, and that, each time a respective filter cell, coming from the discharge zone and containing gas having a pressure of the discharge zone, enters the suspension insertion zone, the pressure in the suspension insertion zone drops,
wherein the rotary pressure filter further comprises equipment that is configured to reduce or to slow the pressure drop of the pressure in the suspension insertion zone each time the respective filter cell coming from the discharge zone enters the suspension insertion zone.

2. The rotary pressure filter according to claim 1, wherein the equipment comprises a liquid insertion zone as a separate treatment zone separated by sealing elements from the other treatment zones, located, with respect to a rotation direction of the filter drum, prior to the suspension insertion zone and after the discharge zone, wherein the liquid insertion zone is adapted to introduce liquid into the filter housing and onto the filter cells.

3. The rotary pressure filter according to claim 2, wherein the liquid is fresh water and/or washing liquid and/or filtrate and/or mother filtrate being a liquid result of a filtration of the suspension of a previous filtration cycle.

4. The rotary pressure filter according to claim 1, wherein the equipment comprises a further suspension insertion zone, as a separate treatment zone separated by sealing elements from the other treatment zones, located, with respect to a rotation direction of the filter drum, prior to the suspension insertion zone and after the discharge zone, wherein the further suspension insertion zone is adapted to introduce suspension into the filter housing and onto the filter cells.

5. The rotary pressure filter according to claim 4, wherein the suspension insertion zone is connected to a first suspension pump conveying suspension to the suspension insertion zone, and that the further suspension insertion zone is connected to a second suspension pump conveying suspension to the further suspension insertion zone, wherein the first suspension pump is different from the second suspension pump.

6. The rotary pressure filter according to claim 1, wherein the equipment comprises that a drainage duct, that is adapted to guide filtrate being filtered through the filter cells out of the filter housing, is in fluid connection with a further treatment zone being succeeding to the suspension insertion zone, and that the suspension insertion zone is closed to the drainage duct such that filtrate being filtered in the suspension insertion zone may leave the filter drum in the succeeding further treatment zone at earliest.

7. The rotary pressure filter according to claim 1, wherein the equipment comprises a gas insertion device being arranged at the suspension insertion zone, wherein the gas insertion device is adapted to introduce an additional gas into the suspension insertion zone being additional to the gas already present in the suspension insertion zone.

8. The rotary pressure filter according to claim 7, wherein the equipment further comprises a check valve that is located, with respect to a gas flow inserted into the suspension insertion zone, on an upstream position of the gas insertion device which is adapted to prevent suspension to exit the suspension insertion zone through the gas insertion device.

9. The rotary pressure filter according to claim 7, wherein the equipment further comprises a pressure detection unit that is adapted to detect the pressure inside the suspension insertion zone, and a gas pump that is adapted to introduce additional gas into the suspension insertion zone when the pressure inside the suspension insertion zone detected by the pressure detection unit falls below a predetermined value.

10. The rotary pressure filter according to claim 7, wherein the gas insertion device comprises a gas reservoir portion that is adapted to be filled with compressed gas prior to an operation of the rotary pressure filter.

11. The rotary pressure filter according to claim 10, wherein the gas reservoir portion comprises an opening being in fluid connection with the inside of the filter housing, and that the opening of the gas reservoir portion is located in a lower half, preferably at a bottom, of the gas reservoir portion with respect to a vertical orientation of the gas reservoir portion in a mounting state of the gas reservoir portion.

12. The rotary pressure filter according to claim 10, wherein the gas reservoir portion comprises an extendible portion that is formed by a stretchable material and/or by a folded wall structure.

13. The rotary pressure filter according to claim 10, wherein the gas reservoir portion is adapted to accommodate suspension from the suspension insertion zone such that the pressure inside the suspension insertion zone and a gas pressure inside the gas reservoir portion are balanced.

14. The rotary pressure filter according to claim 10, wherein the gas reservoir portion is arranged outside of the filter housing.

15. The rotary pressure filter according to claim 1, wherein the equipment comprises at least one sealing element that is chamfered on an edge facing the filter drum and facing the suspension insertion zone such that a filter cell entering the suspension insertion zone opens to the suspension insertion zone in a single point, wherein an area of the filter cell being open to the suspension insertion zone enlarges when the filter drum rotates a respective filter cell further into the suspension insertion zone.
